(19) United States
(12) Patent Application Publication
(10) Pub. No.: US 2016/0178541 A1
(43) Pub. Date: Jun. 23, 2016

(54) APPARATUS FOR ANALYZING THIN FILM

(71) Applicant: SAMSUNG ELECTRONICS CO., LTD., Suwon-si, (KR)

(72) Inventors: Byunghyun HWANG, Yongin-si (KR); Junhwan LEE, Seoul (KR)

(21) Appl. No.: 14/972,879

(22) Filed: Dec. 17, 2015

(30) Foreign Application Priority Data
Dec. 19, 2014 (KR) 10-2014-0184595

(51) Int. Cl. G01N 23/20; G01N 23/203

(52) U.S. Cl. CPC G01N 23/20091; G01N 23/20025; G01N 23/203

(57) ABSTRACT

An apparatus analyzes a thin film having multiple layers. The apparatus includes an X-ray generator, a detector, and a signal processor. The X-ray generator radiates multi-wavelength X-rays sequentially onto a substrate stacked with the multi-layer thin film. The detector detects the multi-wavelength X-rays reflected from the substrate. The signal processor analyzes the multi-wavelength X-rays detected in the detector to determine a thickness of the multi-layer thin film.

### CROSS-REFERENCE TO RELATED APPLICATION

Korean Patent Application No. 10-2014-0184595, filed on Dec. 19, 2014, and entitled, “Apparatus for Measuring Thickness of Thin Film Using Multi-Wavelength X-Rays,” is incorporated by reference herein in its entirety.

### BACKGROUND

1. Field

One or more embodiments described herein relate to an apparatus for measuring a thickness of a thin film using multi-wavelength X-rays.

2. Description of the Related Art

The performance of a transistor may be affected by changes in metal film thickness. In order to detect this thickness and also changes between thin films, film thickness may be analyzed using an X-Ray Reflectometry (XRR) analyzer. The XRR analyzer analyzes the thickness of the thin film based on X-ray wavelength. Thicker thin films may be measured with X-rays having longer wavelengths. Thinner thin films may be measured with X-rays having shorter wavelengths.

### SUMMARY

In accordance with one or more embodiments, an apparatus for analyzing a thin film includes an X-ray generator to radiate multi-wavelength X-rays sequentially onto a substrate stacked with a multi-layer thin film; a detector to detect the multi-wavelength X-rays reflected from the substrate; and a signal processor to analyze the multi-wavelength X-rays detected in the detector to determine a thickness of the multi-layer thin film. The X-ray generator may include a plurality of metal targets including different elements. The metal targets may include different ones of Cr, Fe, Co, Cu, Mo, Ag, V, Mn, Fe, Ni, Zr, or Rh.

The X-ray generator may include a target supporter to support the metal targets; and a rotator to rotate the target supporter. The target supporter may include a plurality of regions arranged substantially in a dart board or fan shape. The metal targets may be in a circular arrangement on the target supporter, and the metal targets may be arranged substantially in a dart board or fan shape.

The rotator may rotate the target supporter for an interval in a range of 5 seconds to 30 seconds, and the rotator may be connected to a position controller to be synchronized with rotation of the metal targets. The X-ray generator may include a beryllium window.

The apparatus may include a monochromator to monochromatize the multi-wavelength X-rays. The apparatus may include a position controller connected to the X-ray generator and the monochromator, and the position controller may adjust a position of the monochromator to correspond to the multi-wavelength X-rays.

In accordance with one or more other embodiments, an apparatus for analyzing a thin film includes a stage to support a substrate stacked with a multi-layer thin film; an X-ray generator to radiate multi-wavelength X-rays sequentially onto the substrate; and a detector to detect the multi-wavelength X-rays reflected from the substrate. The apparatus may include a signal processor to measure and analyze a reflectance of the multi-wavelength X-rays detected in the detector.

The X-ray generator may include an electron beam generator to receive electrons from an electron source and to generate an electron beam; a plurality of metal targets in a region to which the electron beam is radiated, the metal targets including different elements; a target supporter to support the metal targets; and a rotator to rotate the target supporter. The rotator may rotate the target supporter for an interval in a range of 5 seconds to 30 seconds. The target supporter may include at least one of Be, Zr, or Al.

In accordance with one or more other embodiments, an X-ray generator includes a plurality of metal targets; a rotator to rotate the metal targets, wherein X-rays of different wavelengths are radiated when the rotator rotates the metal targets, each metal target including a different element to produce a different X-ray wavelength. The metal targets may be arranged substantially in a dart board shape. The rotator may rotate the metal targets for a predetermined interval, and the predetermined interval may be set to a time which prevents the X-rays of the different wavelengths from overlapping when radiated.

### BRIEF DESCRIPTION OF THE DRAWINGS

Features will become apparent to those of skill in the art by describing in detail exemplary embodiments with reference to the attached drawings in which:

FIG. 1 illustrates an embodiment of an apparatus for measuring the thickness of a thin film using multi-wavelength X-rays;

FIG. 2 illustrates an embodiment of an X-ray generator;

FIGS. 3A-3C illustrate examples of different metal target arrangements;

FIGS. 4A-4C illustrate embodiments of a monochromator;

FIG. 5 illustrates examples of reflectance spectrums of X-rays; and

FIGS. 6A-6B illustrate additional examples of reflectance spectrums of X-rays.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. The embodiments may be combined to form additional embodiments.

It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present.

The terminology used herein is only intended to describe embodiments of the inventive concept and not intended to limit the scope of the inventive concept. As used herein, the singular forms “a,” “an,” and “the” are intended to include the plural forms as well, unless indicated otherwise. The terms “comprises” and/or “comprising” that are used herein specify the presence of mentioned elements, steps, operations, and/or devices, but do not preclude the presence or addition of one or more of other elements, steps, operations, and/or devices.

Further, embodiments are described herein with reference to cross-sectional views and/or plan views that are idealized schematic views of the inventive concept. The thicknesses of layers and parts in the figures are overstated for the effective description of technical content. Thus, shapes of the schematic views may vary according to manufacturing techniques and/or tolerances. Therefore, the embodiments are not limited to the particular shapes illustrated herein but are to include deviations in shapes formed in accordance with the manufacturing process. For example, an etched region illustrated as a rectangular shape may be a rounded shape or a shape of a certain curvature. Thus, the regions illustrated in the figures are schematic in nature, and the shapes of the regions illustrated in the figures are intended to illustrate particular shapes of regions of devices and not intended to limit the scope of the embodiments.

Like numbers refer to like elements throughout the entire text herein. Thus, the same or similar numbers may be described with reference to other figures even if those numbers are neither mentioned nor described in the corresponding figures. Further, elements that are not denoted by reference numbers may be described with reference to other figures.

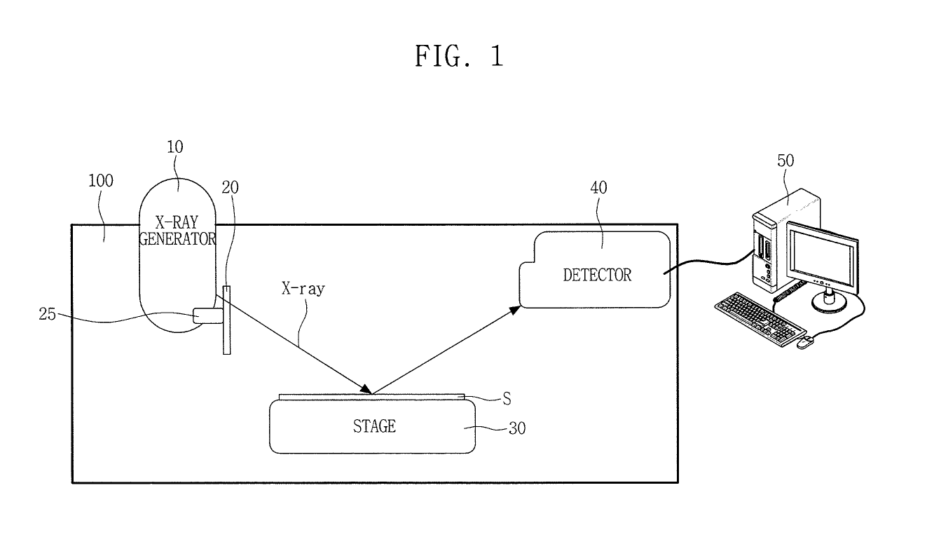

FIG. 1 illustrates an embodiment of an apparatus 100 for measuring the thickness of a thin film using multi-wavelength X-rays. The apparatus 100 may analyze, for example, the thickness, density, and/or roughness of a thin film formed on a substrate and may perform this analysis in an accurate and nondestructive way.

Referring to FIG. 1, the apparatus 100 includes an X-ray generator 10, a monochromator 20, a stage 30, a detector 40, and a signal processor 50. The X-ray generator 10 radiates X-rays of multiple wavelengths onto the surface of a substrate S. The X-ray generator 10 may sequentially radiate the multi-wavelength X-rays for a predetermined time interval. A plurality of metal targets are used to generate the multiple wavelengths of the X-rays in the X-ray generator 10. The metal targets include different metals that generate different X-ray wavelengths, e.g., different elements of the metals generate different X-ray wavelengths. Examples of the metals in the metal targets include Cr, Fe, Co, Cu, Mo, Ag, V, Mn, Fe, Ni, Zr, and/or Rh.

The X-rays may be generated in an X-ray tube having an electron source and two metal electrodes. When a high voltage (e.g., tens of thousands of volts) is generated between the two electrodes, electrons are emitted from a cathode of a power source and strikes a metal target in an anode of the power source at a high speed. As a result, X-rays are radiated.

The X-ray generator 10 may radiate the multi-wavelength X-rays onto the surface of the substrate S at one or more preset incident angles. The preset incident angles may be, for example, in a range of 0° to 5° with respect to the surface of the substrate S. When the X-rays are radiated in this range, interference fringes of variously reflected X-rays are generated, for example, based on the roughness of surface of a multi-layer thin film, the thickness, density of each thin film in a multi-layer thin film, and/or the roughness of an interface between thin films in a multi-layer thin film. Information indicative of the thickness, density, interface roughness of each thin film, and surface roughness of the multi-layer thin film may be measured when the interference fringes are analyzed using known methods.

The monochromator 20 may monochromatize the multi-wavelength X-rays radiated from the X-ray generator 10. For example, a monochromatized X-ray may be obtained from radiated X-rays by dispersing ultraviolet rays and visible light of consecutive wavelengths based on wavelength. The monochromator 20 may include, for example, a slit, a lens, a mirror, a prism, and a diffraction grid. The monochromator 20 may be located at a region into which the multi-wavelength X-rays are radiated from the X-ray generator 10.

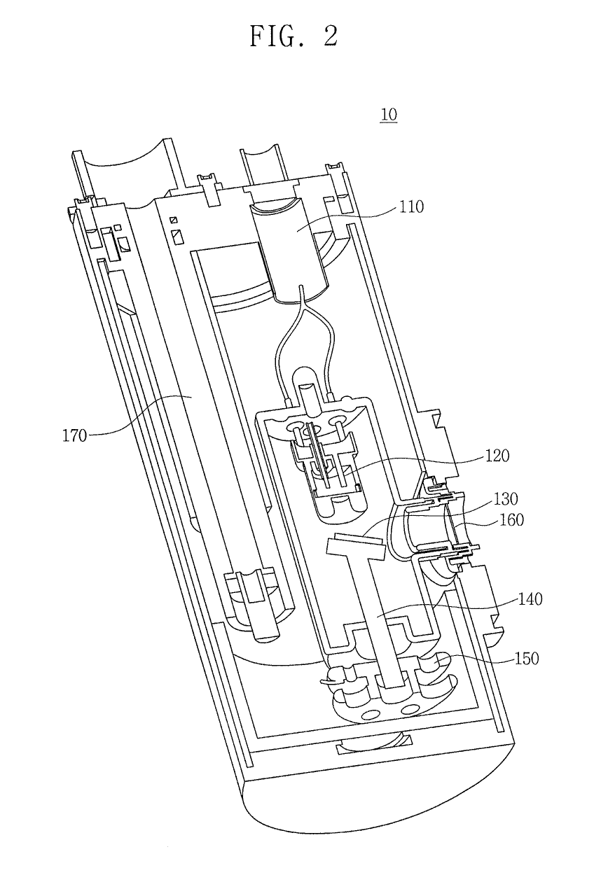

In one embodiment, the monochromator 20 includes a position controller 25 connected to the X-ray generator 10. The position controller 25 adjusts the position of the monochromator 20 to match the wavelengths of the X-rays generated by the X-ray generator 10. Thus, the position controller 25 may be synchronized with rotation of the metal targets in the X-ray generator 10. The position controller 25 may be connected to a rotation unit 150 (see, e.g., FIG. 2) of the X-ray generator 10.

The stage 30 supports the substrate or specimen S, which may include a stack of thin films which may be referred to as a multi-layer thin film. The multi-layer thin film may be, for example, an ONO (oxide-nitride-oxide) film of a flash memory, a ZAZ (ZrO₂—AlO₃—ZrO₂) dielectric film of a capacitor of a DRAM, or another type of film.

The stage 30 is between the X-ray generator 10 and the detector 40, and the multi-wavelength X-rays from the X-ray generator 10 fall incident on the substrate or specimen S. In operation, the incident multi-wavelength X-rays are reflected from each interface (between adjacent ones of the thin films) of the multi-layer thin film on the substrate S. The number of interference occurrences of the X-rays are determined by the number of thin films in the multi-layer thin film.

That is, in the case of changing an incident angle of an X-ray, a reflectance of the X-ray is changed and a wavelength in a form of vibration having a period may be detected.

The detector 40 detects the multi-wavelength X-rays reflected from the substrate S. The detector 40 may detect a sequentially occurring interference fringe of the X-rays based on wavelength, e.g., the detector 40 may measure the reflectance of the multi-wavelength X-rays. The detector 40 may include, for example, a CCD camera or a two-dimensional detector.

The signal processor 50 is connected to the detector 40 and analyzes a detected interference fringe of the multi-wavelength X-rays. The signal processor may be a computer, calculator, logic, or other computing or processing device for performing calculations and analysis as described herein. In one embodiment, the signal processor 50 determines a fast-Fourier-transform (FFT) frequency of a repetitive interference fringe using the FFT of the repetitive interference fringe based on thickness information only. The FFT frequency of the repetitive interference fringe is converted to a thickness, and the thickness of the entire multi-layer thin film may be measured through a lesser assumption and calculation using methods known to those skilled in the art. For example, the reflectance of sequentially occurring multi-wavelength X-rays is sequentially detected and analyzed, and the thickness of the entire multi-layer thin film may be measured.

In one embodiment, the wavelengths of the X-rays generated by respective ones of the metal targets may be reflected differently by different materials in each thin film layer of the multi-layer thin film. The reflectance of these X-rays may generate interference fringe patterns that may allow the thickness, roughness, density, or other qualities to be determined for each thin film layer of the multi-layer thin film and/or for the entire multi-layer thin film. These qualities may provide an indication of how the device including the multi-layer thin film on substrate S may perform.

Thus, according to one embodiment, the apparatus 100 for measuring the thickness of the thin film using the multi-wavelength X-rays accurately measures the thickness of the multi-layer thin film. As a result, the performance of a semiconductor device may be easily determined.

FIG. 2 illustrates an embodiment of the X-ray generator 10 which includes an electron source 110, an electron beam generator 120, a plurality of metal targets 130, a target supporter 140, a rotation unit 150, a window 160, and a high voltage unit 170.

The electron beam generator 120 is connected to the electron source 110 and generates an electron beam when a voltage is applied from the high voltage unit 170. In this embodiment, the electron beam generator 120 is illustrated as a filament tube. In another embodiment, a gas tube may be applied as the electron beam generator 120.

The metal targets 130 may be located in a region into which the electron beam of the electron beam generator 120 is radiated. The metal targets 130 may include a plurality of regions formed, for example, in a dart board shape or a fan shape. The metal targets 130 are struck by the electron beam from the electron beam generator 120 and X-rays are radiated. The X-rays are radiated based on an energy difference when an electron in an inner orbit of an atom is emitted and another electron in the atom enters the inner orbit. The X-rays are formed by an intrinsic line spectrum of each element or a part thereof. Thus, X-rays having an intrinsic property corresponding to each element may be emitted from the metal targets 130 including different elements.

The target supporter 140 supports the metal targets 130. For example, the metal targets 130 may be fixed on the target supporter 140. In another embodiment, the metal target 130 may be a coated metal film on the target supporter 140. The target supporter 140 may be divided into a plurality of regions arranged, in a dart board shape or a plurality of fan shapes, corresponding to the metal targets 130. The target supporter 140 may include, for example, a material which does not have an influence on X-rays emitted from the metal targets 130. For example, the target supporter 140 may include Be, Zr, or Al.

The rotation unit 150 rotates the metal targets 130 to a projection path of an electron beam, so that the electron beam may strike the metal targets 130. The rotation unit 150 may rotate the target supporter 140 to which the metal targets 130 are fixed. For example, the rotation unit 150 may rotate the target supporter 140 so that one of the metal targets 130 may be selected. For example, the rotation unit 150 may rotate the target supporter 140 at a rotation speed in which each of the X-rays emitted from the metal targets 130 does not overlap. The rotation speed may be an interval in a predetermined range, e.g., 5 seconds to 30 seconds. When the rotation speed is less than this range (e.g., 5 seconds or less), the X-rays corresponding to the metal targets 130 may overlap each other. When the rotation speed is greater than this range (e.g., 30 seconds or more), the time to measure the X-rays may be longer. In another embodiment, the rotation speed may correspond to a different interval of time.

The window 160 is arranged on one side of the X-ray generator 10, and may lie in a path in which radiated X-rays are incident to the substrate S. The window 160 may be formed, for example, of beryllium which reduces a loss in X-rays.

The high voltage unit 170 may generate a high voltage to be applied to the electron beam generator 120 and the metal targets 130.

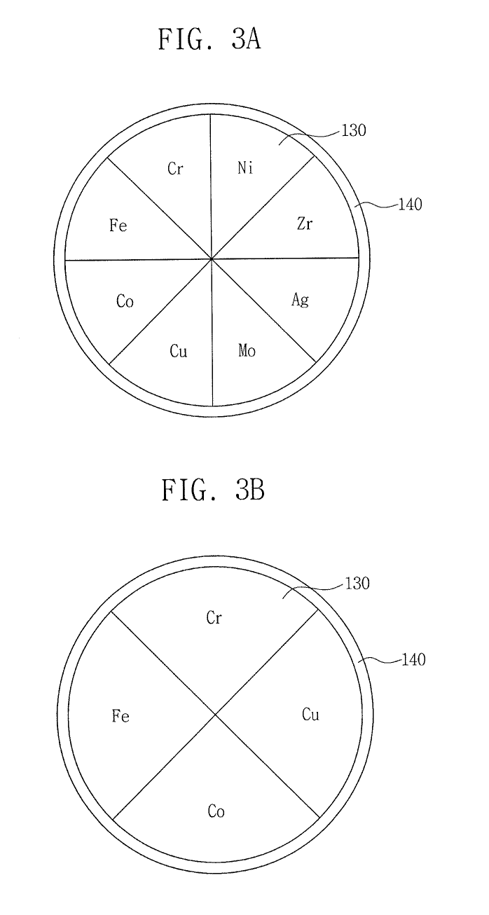

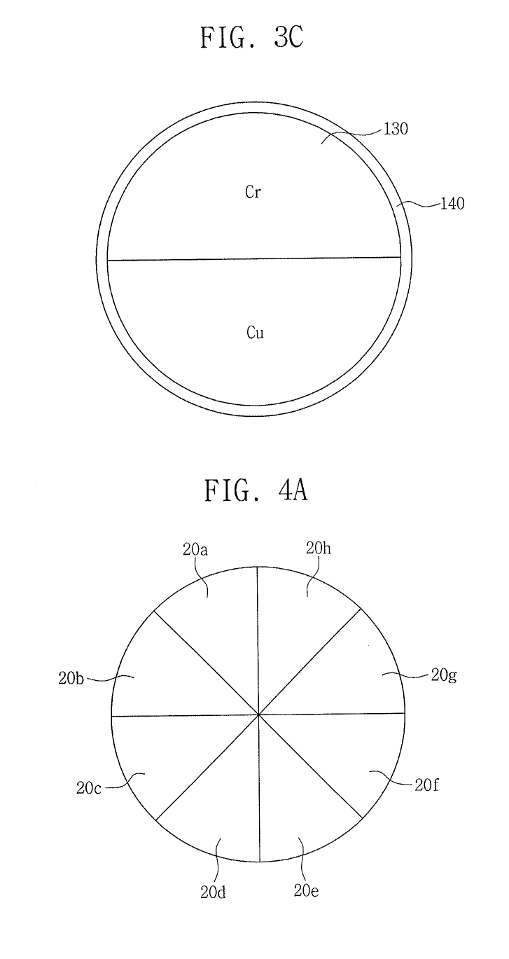

FIGS. 3A-3C are front views of examples of the metal targets 130 of the X-ray generator 10. Referring to FIGS. 2 and 3A-3C, the metal targets 130 are formed of different metals configured to generate respective X-rays having different wavelengths. Each metal target may be formed with a thin metal film to allow penetration by the X-rays. The metal targets 130 are circularly disposed in a dart-board shape so that each metal target is selectively transferred to a projection path of an electron beam by a rotation of the target supporter 140. The target supporter 140 may selectively fix, for example, eight, four, or two metal targets disposed in a circular arrangement. Each of the metal targets 130 has a predetermined shape, e.g., a wedge shape. Taken together, the metal targets, therefore, may resemble a pie or a dart board. Arranged in this manner. The metal targets may be easily changed. In operation, the metal targets 130 are struck by an electron beam at a high speed, and multi-wavelength X-rays may be sequentially radiated therefrom.

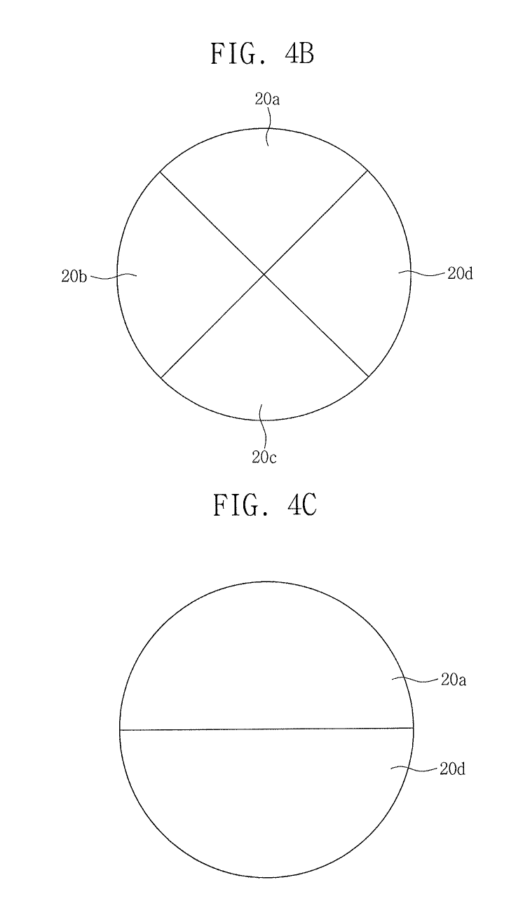

FIGS. 4A-4C are front views of one embodiment of the monochromator 20 which includes eight monochrometers 20a, 20b, 20c, 20d, 20e, 20f, 20g, and 20h corresponding to X-rays generated from respective ones of the metal targets 130, e.g., Cr, Fe, Co, Cu, Mo, Ag, Zr, and Ni. The eight monochrometers 20a, 20b, 20c, 20d, 20e, 20f, 20g, and 20h may be selectively located along a projection path of the X-rays. When the metal targets 130 rotate, the eight monochrometers 20a, 20b, 20c, 20d, 20e, 20f, 20g, and 20h corresponding to the X-rays may also rotate.

Referring to FIGS. 3B and 4B, the monochromator 20 may include four monochrometers 20a, 20b, 20c, and 20d corresponding to respective X-rays of the metal targets 130 having Cr, Fe, Co, Cu, etc. The four monochrometers 20a, 20b, 20c, and 20d may be selectively located in a projection path of the X-rays. When the metal targets 130 having Cr, Fe, Co, and Cu rotate, the four monochrometers 20a, 20b, 20c, and 20d corresponding to the X-rays may also rotate.

Referring to FIGS. 3C and 4C, the monochromator 20 may include two monochrometers 20a and 20d corresponding to respective X-rays of the metal targets 130 having Cr and Cu. The two monochrometers 20a and 20d may be selectively located in a projection path of the X-rays. When the metal targets 130 having Cr and Cu rotate, the two monochrometers 20a and 20d corresponding to the X-rays may also rotate.

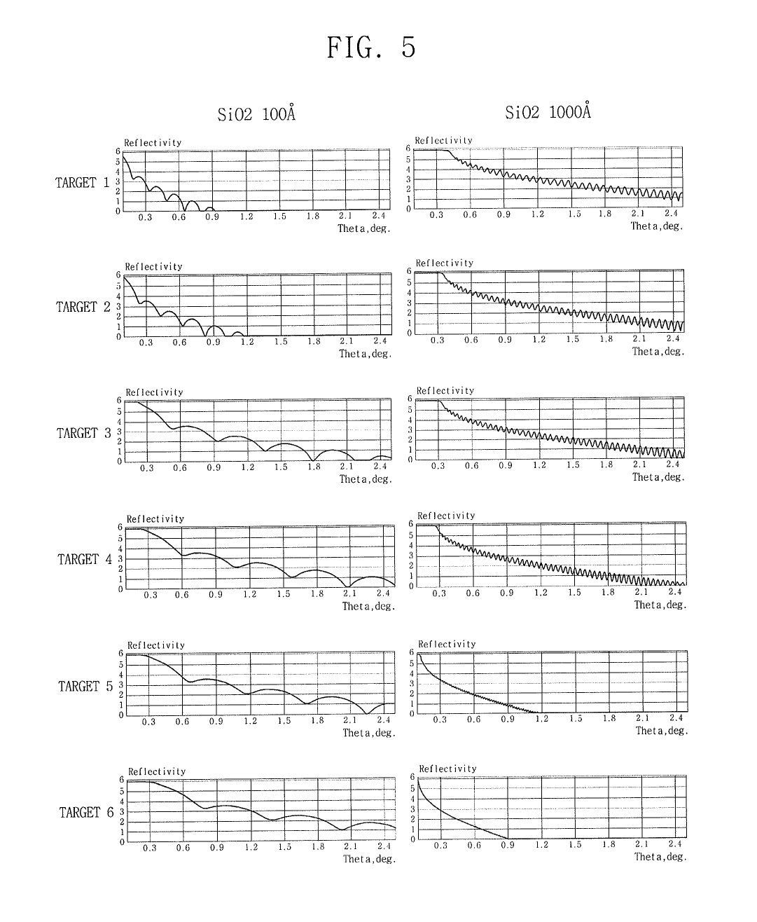

FIG. 5 illustrate graphs of reflectance spectrums of X-rays for specimens based on the metal targets using the apparatus 100 for measuring a thickness of a thin film using multi-wavelength X-rays.

Referring to FIG. 5, the apparatus 100 changed an incident angle from 0° to 3° and sequentially analyzed a specimen based on wavelength. The specimen is a silicon substrate on which a silicon oxide film is stacked. A reflectance spectrum of X-rays was generated using various metal targets for analyzing a silicon oxide film having a thickness of 100 Å. The thickness of the specimen including the silicon oxide film was 1000 Å. In the graphs, the x-axis indicates an incident angle of the X-rays and the y-axis indicates reflectance.

Target 1 included Cr and had a wavelength λ of 2.2897 Å. The reflectance spectrum of the X-rays were examined when a thickness of the silicon oxide film was 100 Å. When an incident angle is greater than or equal to 0.9°, the period of a waveform becomes smaller and reflectance is not measured. The reflectance spectrum of the X-ray is examined when the thickness of the silicon oxide film is 1000 Å. The period of the waveform repetitively appears until the incident angle of greater than or equal to 2.4°, and the reflectance was measured.

Target 2 included Fe and had a wavelength λ of 1.9360 Å. The reflectance spectrum of the X-ray was examined when the silicon oxide film thickness was 100 Å. When the incident angle is greater than or equal to 1.2°, the period of the waveform becomes smaller and reflectance is not measured. The reflectance spectrum of the X-ray is examined when the silicon oxide film thickness is 1000 Å. The period of the waveform repetitively appears until the incident angle of greater than or equal to 2.4°, and the reflectance was measured.

Target 3 included Co and had a wavelength λ of 1.7890 Å. The reflectance spectrum of the X-rays was examined when the silicon oxide film thickness was 100 Å. When the incident angle is greater than or equal to 2°, waveform distortion occurs and reflectance is not measured. The reflectance spectrum of the X-rays is examined when the silicon oxide film thickness is 1000 Å. The period of the waveform repetitively appears until the incident angle of greater than or equal to 2.4°, and reflectance is measured.

Target 4 included Cu and had a wavelength λ of 1.5406 Å. The reflectance spectrum of the X-ray was examined when the silicon oxide film thickness is 100 Å. The period of the waveform repetitively appears until the incident angle of greater than or equal to 2.4° and reflectance is measured. The reflectance spectrum of the X-ray is examined when the silicon oxide film thickness is 1000 Å. When the incident angle is greater than or equal to 2°, the period of a waveform is distorted and a reflectance is not measured.

Target 5 included Mo and had a wavelength λ of 0.7093 Å. The reflectance spectrum of the X-rays was examined when the silicon oxide film thickness was 100 Å. The period of the waveform repetitively appears until the incident angle of greater than or equal to 2.4°, and reflectance is measured. The reflectance spectrum of the X-rays is examined when the silicon oxide film thickness is 1000 Å. When the incident angle is greater than or equal to 1.2°, the waveform period reduces and reflectance is not measured.

Target 6 included Ag and had a wavelength λ of 0.5594 Å. The reflectance spectrum of the X-rays was examined when the silicon oxide film thickness was 100 Å. The period of the waveform repetitively appears until the incident angle of greater than or equal to 2.4°, and the reflectance is measured. The reflectance spectrum of the X-rays is examined for the silicon oxide film thickness of 1000 Å. When the incident angle is greater than or equal to 0.9°, the waveform period reduces and reflectance is not measured.

Thus, when the thickness of the multi-layer thin film of the specimen is analyzed by the embodiments of the apparatus described herein, the thickness of the multi-layer thin film may be more accurately measured.

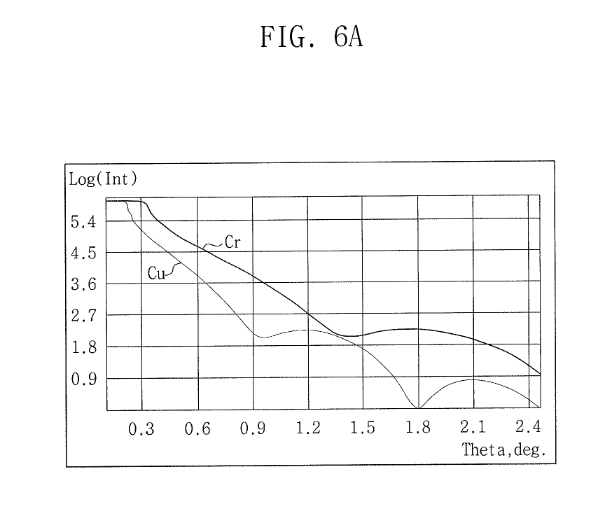

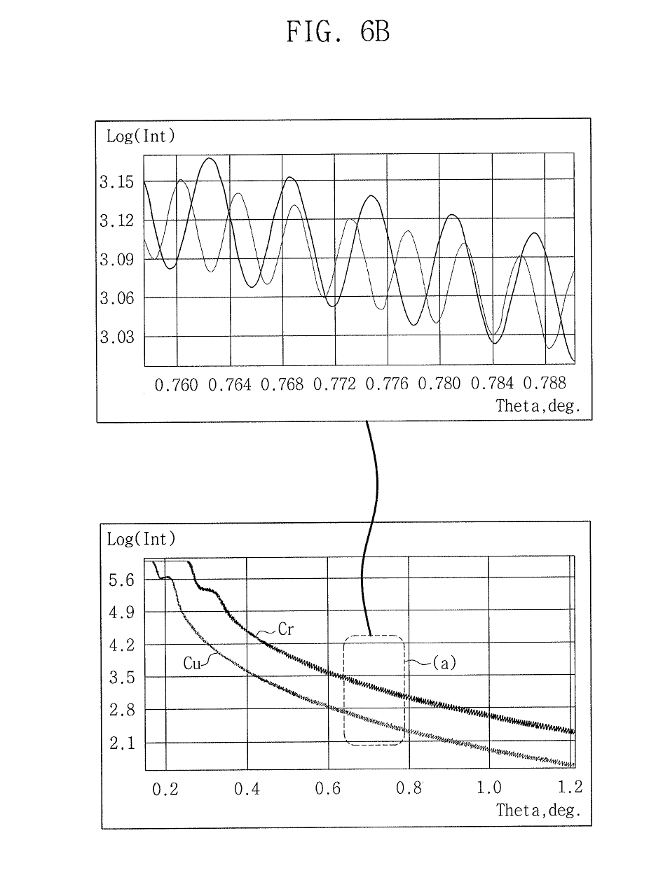

FIGS. 6A-6B illustrate graphs of reflectance spectrums of X-rays measured for a specimen. FIG. 6A illustrates the reflectance spectrum of X-rays measured by apparatus 100 for a thin film of a specimen having a thickness of less than or equal to 100 Å. In the graphs, the X-axis indicates incident angle and the Y-axis indicates the log value of reflectance. In the case of a Cr target, the period of an X-ray waveform is out of a measuring range and cannot be measured. In the case of a Cu target, the period of an X-ray waveform is shown to appear at 0.9° and 1.8°. In this case, the thickness of the thin film of the specimen may be measured by analyzing the period of the X-ray waveform of the Cu target.

FIG. 6B illustrates the reflectance spectrum of X-rays measured by apparatus 100 for a thin film of a specimen having a thickness greater than or equal to 1000 Å. The x-axis indicates incident angle and the y-axis indicates the log value of reflectance. In FIG. 6B, an enlarged resolution area for region A is examined. Here, the thickness of the thin film of the specimen may be measured by analyzing the period of an X-ray waveform of a Cr target and/or the period of an X-ray waveform of a Cu target.

The operations performed by the signal processor 50 may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing the methods described herein.

The signal processor 150 may be implemented in logic which, for example, may include hardware, software, or both. When implemented at least partially in hardware, the signal processor may be, for example, any one of a variety of integrated circuits including but not limited to an application-specific integrated circuit, a field-programmable gate array, a combination of logic gates, a system-on-chip, a microprocessor, or another type of processing or control circuit.

When implemented in at least partially in software, the signal processor may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods described herein.

In accordance with one or more embodiments, a substrate having a multi-layer thin film may be analyzed accurately. Since the thickness of the multi-layer thin film may be accurately measured, it is easy to determine the performance of various semiconductor devices.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the invention as set forth in the following claims.

What is claimed is:

1. An apparatus for analyzing a thin film, comprising:
an X-ray generator to radiate multi-wavelength X-rays sequentially onto a substrate stacked with a multi-layer thin film;
a detector to detect the multi-wavelength X-rays reflected from the substrate; and
a signal processor to analyze the multi-wavelength X-rays detected in the detector.

2. The apparatus as claimed in claim 1, wherein the X-ray generator includes a plurality of metal targets including different elements.

3. The apparatus as claimed in claim 2, wherein the metal targets include different ones of Cr, Fe, Co, Cu, Mo, Ag, V, Mn, Fe, Ni, Zr, or Rh.

4. The apparatus as claimed in claim 2, wherein the X-ray generator includes:
a target supporter to support the metal targets; and
a rotator to rotate the target supporter.

5. The apparatus as claimed in claim 4, wherein the target supporter is divided into a plurality of regions having fan shapes like a dart board.

6. The apparatus as claimed in claim 5, wherein:
the metal targets are in a circular arrangement on the target supporter, and
the metal targets are divided into a plurality of regions having fan shapes like a dart board.

7. The apparatus as claimed in claim 4, wherein:
the rotator is to rotate the target supporter for an interval in a range of 5 seconds to 30 seconds, and
the rotator is connected to a position controller to be synchronized with rotation of the metal targets.

8. The apparatus as claimed in claim 2, wherein the X-ray generator includes a beryllium window.

9. The apparatus as claimed in claim 2, further comprising:
a monochromator to monochromatize the multi-wavelength X-rays.

10. The apparatus as claimed in claim 9, further comprising:
a position controller connected to the X-ray generator and the monochromator, the position controller to adjust a position of the monochromator to correspond to the multi-wavelength X-rays.

11. An apparatus for analyzing a thin film, comprising:
a stage to support a substrate stacked with a multi-layer thin film;
an X-ray generator to radiate multi-wavelength X-rays sequentially onto the substrate; and
a detector to detect the multi-wavelength X-rays reflected from the substrate.

12. The apparatus as claimed in claim 11, further comprising:
a signal processor to measure and analyze a reflectance of the multi-wavelength X-rays detected in the detector.

13. The apparatus as claimed in claim 11, wherein the X-ray generator includes:
an electron beam generator to receive electrons from an electron source and to generate an electron beam;
a plurality of metal targets in a region to which the electron beam is radiated, the metal targets including different elements;
a target supporter to support the metal targets; and
a rotator to rotate the target supporter.

14. The apparatus as claimed in claim 13, wherein the rotator is to rotate the target supporter for an interval in a range of 5 seconds to 30 seconds.

15. The apparatus as claimed in claim 13, wherein the target supporter includes at least one of Be, Zr, or Al.

16. An apparatus for measuring a thickness of a thin film using multi-wavelength X-rays, comprising:
a stage configured to support a substrate stacked with a multi-layer thin film;
an X-ray generator configured to radiate multi-wavelength X-rays sequentially onto the substrate;
a detector configured to detect the multi-wavelength X-rays reflected from the substrate; and
a signal processor configured to analyze the multi-wavelength X-rays detected in the detector.

17. The apparatus of claim 16, further comprising:
a monochromator configured to monochromatize the multi-wavelength X-rays; and
a position controller connected to the X-ray generator and the monochromator, and configured to adjust a position of the monochromator so as to correspond to the multi-wavelength X-rays.

18. The apparatus of claim 17, wherein the X-ray generator comprises:
an electron beam generator configured to receive electrons from an electron source and generate an electron beam;
a plurality of metal targets located in a region into which the electron beam is radiated, and formed of various elements;
a target supporter configured to support the plurality of metal targets;
a rotation unit configured to rotate the target supporter; and
a window which is an incident path of the multi-wavelength X-rays emitted from the plurality of metal targets.

19. The apparatus of claim 18, wherein the window includes beryllium.

20. The apparatus of claim 18, wherein the rotation unit rotates the target supporter for an interval in a range of 5 seconds to 30 seconds, and the position controller is connected to the rotation unit and synchronized with a rotation of the plurality of metal targets.
